(19) United States
(12) Patent Application Publication
(10) Pub. No.: US 2012/0028791 A1
(43) Pub. Date: Feb. 2, 2012

(54) Highly Reactive Photocatalytic Material and Manufacturing Thereof

(76) Inventors: Lars Österlund, Umea (SE); Gunnar Westin, Stockholm (SE); Michael Leideborg, Saltsjo-Boo (SE)

(21) Appl. No.: 13/259,462

(22) PCT Filed: Mar. 24, 2010
(86) PCT No.: PCT/SE2010/050320

§ 371 Date: Sep. 23, 2011

(30) Foreign Application Priority Data
Mar. 24, 2009 (SE) 0950182-6

(51) Int. Cl. B01J 21/06; B01J 31/02; B82Y 30/00; B82Y 40/00

(52) U.S. Cl. 502/171; 502/350; 977/773; 977/896

(57) ABSTRACT

A method for manufacturing anatase TiO₂ nanoparticles comprises mixing (210) of Ti-containing alkoxide precursors with a solvent into a precursor solution, hydrolyzing (212) the precursor solution to yield a mixture of a fine titanium containing precipitate and the solvent and hydrothermally treating (214) the precipitate at an elevated temperature in a basic medium. The basic medium is provided after the hydrolysis. The basic medium comprises basic amines. A highly active photocatalytic material is thus presented, comprising anatase TiO₂ nanoparticles, which have a mean diameter of less than 100 nm and have at least one of a {111}, a {112}, and a {100} crystal face. The material can be tuned for selective carboxylate-surface coordination.

### TECHNICAL FIELD

The present invention relates in general to photocatalytic materials and manufacturing thereof, and in particular to anatase TiO₂ particles with beneficial surface structure and morphology and manufacturing thereof.

### BACKGROUND

Photocatalysis is the technical term for photon-induced surface processes initiated by light absorbed within a solid catalyst [1]. Photocatalysis concerns primarily photon-induced processes occurring on semiconducting nanoparticles and particularly those occurring on wide band gap semiconductors with titanium dioxide (TiO₂) as the prime example. Technical applications include air and water cleaning, solar hydrogen and electricity production, self-cleaning and antibacterial coatings and green chemical synthesis [1]. Today most commercial applications utilize TiO₂ as photocatalyst. TiO₂ has advantageous physical and chemical properties, it is biological inert, it is photostable and cost-effective. The most common crystal modifications of TiO₂ are anatase, rutile and brookite. They have different electronic properties with slightly different energy band dispersion with different band gaps and symmetries of band gap interband transitions. The basic principle underlying TiO₂ photocatalysis relies on photon-induced electronic interband transitions from the valance band (VB) to the conduction band (CB) in the semiconductor that creates electron-hole pairs. The hot electrons in the CB and the vacancies (holes) in the VB that reach the semiconductor surface can initiate redox processes with adsorbed molecules from the surrounding media (gas, liquid or solid). In TiO₂ where the crystal bonds have ionic character the VB and CB energy bands are rather flat and have predominantly oxygen (O 2p) and Ti (Ti 3d) character, respectively. The exact position of the VB and CB band energy extremes determines the band gap and whether the interband transition is direct or indirect. Anatase is an indirect semiconductor, while contradictory results have been reported for rutile. The similarity of brookite to anatase may indicate that it also is an indirect semiconductor.

In general, the surface atomic arrangement and free energy of a crystal vary with the crystallographic orientation. Therefore, the electronic properties and reactivity as well as other physico-chemical properties of crystals depend on their shape. Hence it is of utmost importance to be able to control and modify the morphology of crystals to tune their reactivity. The {101} and {001} crystal faces are reported to have the lowest surface energy of anatase, while the {110} crystal facets of rutile have much lower surface energy than other facets [2, 3]. As a consequence of these thermodynamic constraints rutile particles expose in general a large fraction of {110} planes to minimize their surface energy. In contrast, anatase which has several low index crystal facets with similar surface energy may exhibit different crystal morphologies exposing different fractions of low index facets. The minimum free energy morphology of an anatase crystal calculated by the Wulff construction exhibits a truncated tetragonal bipyramidal structure exposing {101} and {001} faces, where more than 90 percent of the surface are {101} faces [2].

The (101) surface of anatase is reported to be quite unreactive and do not promote water, methanol and formic acid dissociation [3-5]. In contrast it has been reported that the (001) surface is reactive: It spontaneously reconstruct under ultra-high vacuum conditions and water spontaneously dissociated on the non-reconstructed (001) surface [6]. The photocatalytic activity of anatase TiO₂ crystals with different morphologies, facet distribution and surface atomic arrangements other than that dictated by thermodynamics have been the subject of only few reports. Yang et al [7] reported on a method to synthesize 1.6 μm sized anatase crystals with a large fraction of {001} faces by using fluorine-terminated surfaces to change the relative stability of {101} and {001} surfaces. They synthesized uniform anatase TiO₂ crystals with a high percentage (47%) of {001} faces using hydrofluoric acid as a morphology controlling agent. Moreover, they showed that fluorated surfaces of anatase single crystals can easily be cleaned using heat treatment to render a fluorine-free surface without altering the crystal structure and morphology. Byun et al [8] reported on a CVD method to prepare anatase TiO₂ thin films with preferred <112> orientation. The so produced <112> orientated films are not smooth and are not presenting any well-defined faces. Instead, they resulted in a larger surface area for photocatalytic reaction by forming columnar structure with deeper voids on the film surface. Among the films they prepared those that exhibited <112> orientation showed the highest photocatalytic reaction rate for benzene decomposition and was attributed to columnar structure and larger surface area of these films. In a later study Kim et al [9] compared SEM micrographs of the surface morphology and cross sectional images of <112> and <001>-oriented anatase TiO₂ films. They concluded that surface of the <001> oriented film was denser than that of the <112> oriented film. The authors suggested that the <112> oriented films consisted of {100} and {004} faces and exhibited an open columnar structure perpendicular to the substrate, while the <001> oriented film exhibited densely aggregated columns. Jhin et al [10] reported a CVD method for preparation of anatase TiO₂ films with enhanced <112> orientation on soda-lime glass by plasma pretreatment of the substrate. Tokita et al [11] prepared anatase films on non-epitaxial substrates by a CVD method. The films exhibiting <110>, <100>, <112> and <001> crystal orientation showed high photocatalytic activity for methylene blue reduction. Among them the <112> oriented film had the highest reactivity. The actual facets presented at the film surface were not analyzed.

Ohno et al [12] studied the crystal face dependent photocatalytic reactivity of 1 μm large rutile and anatase crystals obtained from Toho Titanium Company. The truncated tetragonal bipyramidal shaped anatase particles exposing {101} and {001} faces. Photocatalytic reduction of hexachloroplatinate resulted in Pt deposits on all faces of the anatase crystals only when isopropanol was added to the solution. By monitoring the amount of deposits on various crystal surfaces they showed that the anatase {001} faces pre-coated with Pt were more reactive for Pb²⁺ oxidation to PbO₂ than the {101} faces. They thus concluded that the {001} and {101} faces provide oxidative and reductive sites, respectively. In another study Taguchi et al [13] etched the micro-sized anatase particles. By comparing the structure determined by SEM before and after etching they showed that by this process the edge between two {101} faces is selectively etched thus forming new {112} faces. Large PbO₂ deposits are observed in SEM on the {112} faces when Pb²⁺ was photocatalytically oxidized on the Pt-deposited TiO₂ particles. The oxidative activity of the {112} face was considered to be stronger than that of the {001} face, which acts as the oxidative site on the TiO₂ particles before etching because no PbO₂ deposits were seen on the {001} face of the etched particles.

In [24], TiO₂ nanoparticles were prepared using the hydrolysis of titanium tetraisopropoxide (TTIP) using tetraethylammoniumhydroxide (TENON) as a peptizing agent in the hydrothermal method. The physical properties of prepared nanosized TiO₂ particles were investigated. Small anatase particles in the nanometer range were possible to obtain.

In [23], adsorption and solar light decomposition of acetone was studied on nanostructured anatase TiO₂ and Nb-doped TiO₂ films. The films were made by sol-gel methods using a solution of a precursor mixture of Ti(OPrⁱ)₄ and Nb(OEt)₅. in an ethanol solvent. Concentrated ammonia was added and a hydrothermal treatment was performed. Nanosizes distorted anatase particles were formed, doped with Nb.

A problem with prior art TiO₂ photocatalysts produced in a well controlled manner is that the photocatalytic activity generally is low. It is desirable to manufacture improved photocatalytic materials.

### SUMMARY

An object of the present invention is to provide photocatalytic materials having an improved photocatalytic activity and methods for manufacturing such photocatalytic materials in a well-controlled manner.

The above objects are achieved by methods and materials according to the enclosed patent claims. In general words, in a first aspect, a photocatalytic material comprises anatase TiO₂ nanoparticles, which have a mean diameter of less than 100 nm and have at least one of a {111}, a {112} and a {100} crystal face.

In a second aspect, a method for manufacturing anatase TiO₂ nanoparticles according to the first aspect comprises mixing of Ti-containing alkoxide precursors with a solvent into a precursor solution, hydrolyzing the precursor solution to yield a mixture of a fine titanium containing precipitate and the solvent. A mixture of a basic medium, comprising basic amines diluted with de-ionized water, and the precipitate of the hydrolyzed precursor solution is provided. The mixture is heated and further hydrothermally treated at an elevated temperature for 1-48 hours.

An advantage with the present invention is that materials having an improved photocatalytic activity are provided in a well-controlled manner.

### BRIEF DESCRIPTION OF THE DRAWINGS

The invention, together with further objects and advantages thereof, may best be understood by making reference to the following description taken together with the accompanying drawings, in which:

FIG. 1 shows TEM micrographs of anatase TiO₂ nanocrystals with an average diameter of about 25 nm;

FIG. 2 shows TEM micrographs of anatase TiO₂ nanocrystals with an average diameter of about 40 nm according to an embodiment of the present invention;

FIG. 3 is a scanning electron microscopy image of a thin film comprising anatase TiO₂ nanocrystals;

FIG. 4 is a X-ray diffractogram of anatase TiO₂ nanoparticles with an average particle size of 25 nm;

FIG. 5 is a X-ray diffractogram of anatase TiO₂ nanoparticles with an average particle size of 40 nm according to an embodiment of the present invention;

FIG. 6 shows a TEM micrograph and selected area electron diffractogram of 25 nm anatase TiO₂ nanocrystals orientated in different directions with respect to the imaging plane;

FIG. 7 shows a TEM micrograph and selected area electron diffractogram of 40 nm anatase TiO₂ nanocrystals orientated in different directions with respect to the imaging plane;

FIG. 8 presents crystal morphologies that matches TEM and XRD data, which shows the presence of {112}, {101}, and {001} crystal faces;

FIG. 9 presents the crystal morphologies that matches TEM and XRD data, which shows the presence of {100}, {101}, and {001} crystal faces;

FIG. 10 presents the crystal morphologies that matches TEM and XRD data, which shows the presence of {112}, {100}, {101} and {001} crystal faces;

FIG. 11 presents crystal morphologies that matches TEM and XRD data, which shows the presence of {112}, {111}, {100}, {101}, and {001} crystal faces;

FIG. 12 are in situ FTIR spectra showing the photodegradation of formate preadsorbed anatase nanoparticles after different times (0, 6 and 48 min) of solar light illumination;

FIG. 13 is a diagram illustrating the ratio of the surface concentration of formic acid and intermediate residual products before and after solar light irradiation;

FIG. 14 is a flow diagram illustrating steps of an embodiment of a method according to the present invention; and

FIG. 15 illustrates possible types of carboxylate surface coordination bonding schemes on TiO₂.

### DETAILED DESCRIPTION

In one aspect, the invention discloses methods and principles to prepare TiO₂ nanoparticles with appropriate size, morphology and surface atomic arrangement that are beneficial for achieving high photocatalytic activity. In particular, the photocatalytic oxidation of simple organic molecules is used as a model reaction. The reactions take place on anatase TiO₂ nanoparticles prepared by solution based methods that expose large areas of at least one of a {112}, a {111} and a {100} crystal face possibly co-existent with {101} and/or {001} crystal faces. The principle mechanisms responsible for their reactivity are outlined further below and methods to tune the reactivity for desired purposes are described. The invention also discloses methods to coat the photocatalytic materials onto various substrates for practical applications.

From the background survey, it can be concluded that there are no reports available to this date that describes the photocatalytic reactivity of the (112), (100) and (111) anatase surfaces for organic molecules. There are no reports that treats the photocatalytic activity of anatase TiO₂ nanoparticles below 100 nm that exposes {112}, {111}, and/or {100} faces. Reports of large anatase crystals and minerals exhibiting a truncated ditetragonal bipyramidally terminated by {100}, 111}, {112} and {001} have been published elsewhere before but have not been related to catalysis, in particular not to photocatalysis, nor in relation to coordination of carboxylic groups.

A general feature governing the reactivity of anatase TiO₂ surfaces is considered to be (i) the high density of coordinatively unsaturated surfaces sites, and (ii) the strained configuration of the surface atoms exhibiting large Ti—O—Ti bond angles within the surface plane [14] and small nearest-neighbor (nn) Ti—Ti distances [15]. The nn Ti—Ti distance in bulk terminated (un-reconstructed) anatase (101) is 3.783 Å, and it is the same in the anatase (001), (100) and (112) surfaces, while it is much shorter (2.953 Å) in rutile (110). The Ti—O—Ti bond angles differs however considerably among the (101), (111), (100), (112) and (001) surfaces, with the (101) exhibiting the lowest Ti—O—Ti bond angle within the surface plane (along the [10-1] direction), while the others have a strained angle (102 vs. 155 degrees for the bulk terminated structure).

The present disclosure therefore describes how crystalline, anatase TiO₂ nanoparticles that expose open surface structures, in particular {112}, {111} and {100} crystal faces, and are characterized by a high density of coordinatively unsaturated surfaces atoms and strained atomic configuration with large Ti—O—Ti bond angles within the surface plane as compared to the angle in the anatase (101) plane along the [10-1] direction, are correlated with a high photocatalytic activity. In particular their high photocatalytic oxidation rate is described.

The invention described here concerns photocatalytic active anatase TiO₂ nanoparticles exposing a large fraction of reactive {112}, {111} and {100} crystal faces and methods and principles to prepare them. The anatase TiO₂ nanoparticles have a mean diameter of less than 100 nm. Preferably they have a mean diameter in the range of 20-80 nm, and more preferably in the range of 30-60 nm. Embodiments of the invention present crystal particles contained either in powders or films with a desired morphology described by a ditetrahedral truncated bipyramidal structure or a truncated bipyramidal structure. It is concluded that the preferred crystal faces and surface facet distributions are the following. The area fraction of {112} crystal faces to total crystal area should preferably be in the range of 0-50%, and more preferably between 20 and 40%. The area fraction of {100} crystal faces to total facet area should preferably be in the range of 5-30%, and more preferably between 5 and 20%. The fraction of {111} faces should preferably be in the range 0-20%, more preferably between 5 and 15%. Typically, {001} crystal faces are also present, typically in an amount of 1 to 20% compared to a total facet area. The nanocrystals always expose additional {101} faces.

The embodiments of the invention present anatase particles with an average size in the 20-100 nm range as determined by Scherrer analysis of the (101) X-ray diffraction peak. The preferred particle size is considered to be 20-80 nm, and in particular 30-60 nm. The particle size distribution should be narrow, preferably within 40% and in particular within 25% of the mean particles diameter as defined by the Full-width at half maximum of the XRD peaks originating from (101) anatase planes.

The invention discloses anatase nanoparticles that are efficient photocatalysts for the oxidation of organic molecules, water and inorganic molecules containing hydrocarbon moieties. Suitable applications of such anatase nanoparticles with beneficial surface atomic arrangement are e.g. for air or water cleaning or hydrogen production. The invention can be applied for photocatalytic degradation of organic pollutants, especially hydrocarbons, ketones, alcohols, carboxylic acids, and carboxylates thereof. In particular, it is suitable for photocatalytic oxidation of hydrocarbons, ketones, water, and alcohols.

The present disclosure presents solution based methods [16-20] to synthesize the anatase TiO₂ nanoparticles with the above mentioned beneficial surface atomic arrangement. In particular, a solution based method employing alkoxide precursors is used. The Ti-containing alkoxide precursors preferably comprise a titanium(IV) alkoxide including ligands selected from the group of methoxo, ethoxo, propoxo, butoxo, pentoxo and hexoxo ligands, and more preferably at least one of titanium tetraisopropoxide Ti(OPr¹)₄ and titanium tetrabutoxide Ti(OBuⁿ)₄. The alkoxides are weighed and manipulated under inert atmosphere in a glove-box or with a Schlenk-type vacuum line. The Ti-containing alkoxide precursors are mixed with a solvent into a precursor solution. The solvent preferably comprises at least one of ethanol and propanol. The solvent may further comprise ethanol and/or propanol together with at least one of hexane, pentane, heptane, tetrahydrofuran (THF), benzene, toluene and xylene. The mixture has preferably a concentration of 0.01-1.2 M, more preferably 1.0 M when titanium tetraisopropoxide Ti(OPrⁱ)₄ is used and more preferably 0.5 M when titanium tetrabutoxide Ti(OBun)₄ is used. The precursor solution is hydrolyzed to yield a mixture of a fine titanium containing precipitate and the solvent.

The methods for producing the anatase TiO₂ nanoparticles further comprise a hydrothermal treatment of this precipitate at an elevated temperature, in the presence of a basic medium. The basic medium is provided at the earliest in connection with the hydrolysis. In other words, the provision of the basic medium can be provided during the hydrolysis, but may also be provided after the hydrolysis but before the hydrothermal treating starts, according to different embodiments of the present invention. The basic medium comprises at least one of ammonia and basic amines. When the basic medium comprises ammonia, preferably concentrated ammonia and most preferably ammonia in an amount of at least 25 weight-% is used. When the basic medium comprises strongly basic amines, these amines are preferably selected from the group of mono-, di- and tri-substituted amines with alkyl groups and quartenary tetraalkylamines, and most preferably N(CH₃)₄.OH. It is also preferred to utilize ultra sound treatments at different occasions during the process.

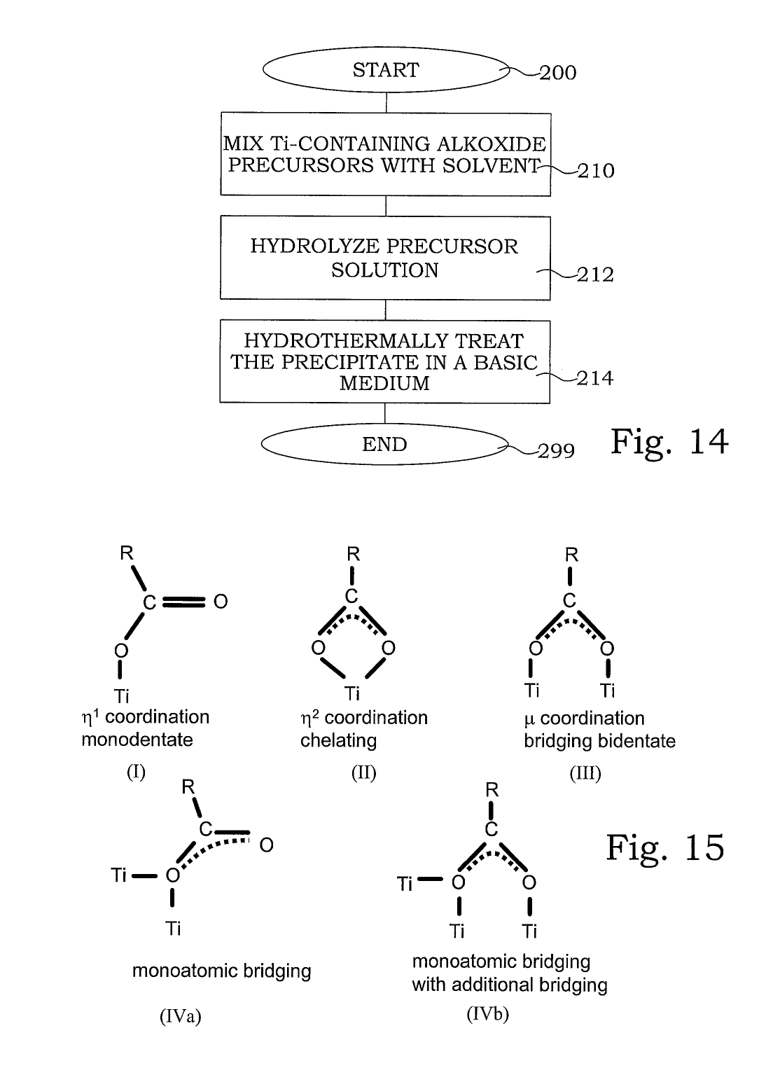

FIG. 14 illustrates steps of an example of a general method for producing anatase TiO₂ nanoparticles. The method for manufacturing of anatase TiO₂ nanoparticles starts in step 200. In step 210, Ti-containing alkoxide precursors are mixed with a solvent into a precursor solution. The precursor is hydrolyzed in step 212 to yield a mixture of a fine titanium containing precipitate and the solvent. In step 214, the precipitate is hydrothermally treated at an elevated temperature in the presence of a basic medium. The basic medium is provided at the earliest in connection with the hydrolysis. The basic medium comprises at least one of ammonia and basic amines. According to the present invention, the basic medium comprises basic amines diluted with de-ionized water and is provided after the hydrolyzing step. The mixture is then heated. The method ends in step 299.

The methods for producing anatase TiO₂ nanoparticles will be described more in detail by use of two examples of which the second example corresponds to a preferred method according to the present invention.

### Example 1

Preparation of anatase TiO2 with an average particle size of 25 nm that exhibit a beneficial surface atomic arrangement was made by solution based methods as described here below. Titanium(IV) tetraisopropoxide (Ti(OPrⁱ)₄) was mixed with ethanol to yield a solution with a concentration of 1 M. The alkoxides were weighed and manipulated under inert atmosphere in a glove-box or with a Schlenk-type vacuum line. All glass and the Teflon lined stirrer bars used in the synthesis were dried by heating at 150° C. for at least 30 min. prior to use. Absolute ethanol (99.5%) was distilled under inert atmosphere (typically nitrogen) from a mixture of calcium hydride and ethanol. The alkoxide was mixed with the ethanol solvent in a 250 cm³ round bottom flask with a 5 cm magnetic stirrer bar and then the flask was sealed with a butyl-rubber septum. The solution was taken out of the glove box and in this particular case heated in an oil bath to ˜60° C. which was maintained for at least 30 minutes and in the present example 1 hour; all under stirring at 150 rpm. The temperature is preferably kept within the interval 25-85° C. The heating and stirring is provided for homogenization and equilibrium in alkoxo-group exchange, and the heating period is preferably kept in the interval 15 minutes to 24 hours, preferably within the interval 0.5 hours to 8 hours and most typically around 1 hour.

After cooling to room temperature, the Ti(OPrⁱ)₄ solution was hydrolyzed under vigorous stirring by rapid addition of a basic medium, in this example concentrated aqueous ammonia. In this example, the amount of concentrated ammonia was so large that 5 H₂O per alkoxo group, i.e. 20 H₂O per Ti, was added. The concentrated ammonia was added as quickly as possible with one shot using syringes armed with a 2 mm diameter needle. The stirring was maintained for about 10 min at spin rates of 1000-1500 rpm to facilitate de-agglomeration of larger particle aggregates to produce a homogenous mixture of fine, solid particles in the solution.

The basic medium in this example comprises ammonia, preferably concentrated ammonia and most preferably concentrated ammonia in an amount of at least 25 weight %. In alternative examples, the basic aqueous medium can also be constituted by strongly basic amines including mono- di- tri-substituted amines with alkyl groups, and quartenary tetralkylamines, and in particular N(CH₃)₄OH or tetramethylaminehydroxide pentahydrate (N(CH₃)₄OH.5H₂O).

Furthermore the basic medium should preferably be provided in amounts bringing an excess of H₂O to alkoxo groups (OR), in order to achieve complete hydrolysis and thereby avoid organic residues in the final product. Preferably, the basic medium is added in amounts giving 1-1000 H₂O per alkoxo group, more preferably 2-60 H₂O per alkoxo group, and most preferably 2-10 H₂O per alkoxo group.

The mixture was transferred to a 1 dm³ Ehrlenmayer (E)-flask, marked to indicate the level yielding a mixture of a dry-weight of 5 weight-%. Evaporation at temperatures up to, but in the present example not above 80° C. for 8 hours, yielded a concentrated mixture. In alternative examples, the mixture should be heated to 40-90° C., in particular 80° C. and held at the temperature for 4-12 hours at that temperature, in particular 6-10 hours. The heat treatment was conducted so that the level of the mixture volume never was lower than the marked volume, but it might be allowed to be slightly higher. The evaporation was compensated by addition of de-ionized water. The mixture was stirred at approximately 100 rpm during heat treatment and the flask was flushed with dry, inert gas under low pressure, to increase the evaporation rate. The mixture was then transferred to a 400 cm³ beaker and ultra-sonically treated under stirring at about 500 rpm for 20 minutes with 70-80% effect of a full ultrasonic effect of 475 W with duty-cycle 50%. This corresponds to level 7 of 10. The effect was thus approximately equal to 330 W at 100% duty cycle for 10 minutes. The ultra sound treatment was aimed to further facilitate break-up of particle clusters.

The ultra-sonically treated mixture was then transferred to a Teflon cup or similar inert cell in an autoclave so that the liquid occupied 70-80% of the volume. In other examples, the liquid takes up 20-80% of the volume and in further other examples 40-70%. After closing, the autoclave was in the present example heated to 200° C. which was held for 15 hours. In other examples, the temperature interval is 160-300° C., preferably 180-250° C. and the duration of the hydrothermal treatment is in the range of 1-48 hours and in particular in the range of 3-20 hours. After the hydrothermal treatment the oven was turned off and the autoclave was allowed to cool to room temperature at the cooling rate of the furnace, typically taking about 4-8 hours. After transfer to a glass beaker, the cooled mixture was again subjected to ultra-sonic treatment in the same way as described above.

The dry-weight of the mixture, i.e. the oxide content, was about 5 weight-%. This was determined by evaporation of small part of the mixture, about 0.1 g corresponding to about 2 cm³, at an elevated temperature, about 200° C. Based on this result, the mixture was distilled to remove water until a dry content of 10-25 weight-%, in this particular example 13.5 weight-%, was obtained. The amount of water to be evaporated was calculated from the weight of the mixture and the determined dry-weight. The mixture was distilled under stirring, heating and reduced pressure. The pressure was not lower than 1.2 mbar, During this evaporation the temperature was never allowed to exceed a limit temperature selected in the interval 20-80° C. and in particular in the interval 50-80° C. The evaporated volume was weighed and in case of excess evaporation, de-ionized water was added to compensate for loss of water.

A polyfunctional organic polymer, carbowax or similar, should preferably be added to the resulting paste. The dry-weight was determined after distillation to calculate the amount to add. The amount to add to the paste should be about 10-80 weight-% of the solid content of TiO₂, in particular 40-60 weight-%. In this particular example the poly-functional organic polymer added was about 50 weight-% of the dry content of TiO₂. The mixture was stirred for 10-40 hours, preferably 15-30 hours and in this particular example 24 hours, for the carbowax to be allowed to be homogenized in order to yield a white paste. The paste could be used directly, or after dilution with de-ionized water or with acidic solutions for preparation of films.

An example of a TEM image of anatase particles prepared according to the method described here above is shown in FIG. 1. Anatase TiO₂ nanocrystals with an average diameter of about 25 nm are inferred to expose {101}, {112}, {100}, {111} and {001} crystal faces (c.f. also FIGS. 8-11).

### Example 2

Preparation of anatase TiO₂ with an average particle size of 40 nm that exhibit a beneficial surface atomic arrangement was made by solution based methods according to the present invention as described here below. Titanium(IV)tetrabutoxide (Ti(OBuⁿ)₄) was mixed with isopropanol to yield a concentration of 0.5 M. All glass and the Teflon lined stirrer bars used in the synthesis were dried by heating at 150° C. for at least 30 min. All handling of precursor, e.g. weighing and manipulating of alkoxides, and solvents and precursor solution was conducted in a glove-box with an inert atmosphere, in this embodiment a dry Ar atmosphere or nitrogen, or with Schlenk-type vacuum line technique. Absolute isopropanol (p.a. 99.5%) was distilled under inert atmosphere from a mixture of calcium hydride and isopropanol. The alkoxide was mixed with the isopropanol solvent in a 100 cm³ wedge shaped flask with a 2 cm magnetic stirrer bar. The 0.5 M alkoxide solution was homogenized by stirring for a minimum of 30 minutes. The flask with the alkoxide solution was sealed with a butyl-rubber septum

The Ti(OBun)4 solution was hydrolyzed at 25° C. by rapid, drop-wise addition in a stream of an inert gas flow at low pressure, typically dry nitrogen, via Teflon tubing to de-ionized water. By adjusting the gas pressure, a rapid drop-wise addition of the alkoxide solution was made to a 250 cm³ E-flask with de-ionized water rapidly stirred at about 800 rpm. The addition took place during a period of typically 1-60 minutes, preferably 10-30 minutes and in the present embodiment 15 minutes. The rapid, drop-wise addition of the alkoxide solution to de-ionized water should be made to provide typically 1-1000 H₂O per alkoxo group and preferably 2-60 H₂O per alkoxo group. In the present embodiment, the precursor solution was hydrolyzed with an n(H₂O)/n(Ti) molar ratio of 150. The solid part of the mixture, i.e. solid fine precipitate in the solution, produced by the hydrolysis was sedimented by centrifugation at 2500 rpm for 20 minutes to separate the solid material from the solvent, followed by removal of the upper solution phase. Then de-ionized water was added and de-agglomeration was made by stirring with a Teflon rod. The process of washing the precipitate was made four times.

The final washed precipitate was diluted with de-ionized water and a strong organic base was added. The strong organic base could include mono-, di-, or tri-substituted amines with alkyl groups, and quartenary tetralkylamines, and in particular N(CH₃)₄OH or tetramethylaminehydroxide pentahydrate (N(CH₃)₄OH.5H₂O). The molar ratio n(H₂O)/n(Ti) was selected in the range of 30-600 and preferably in the range of 75-300, and the molar ratio n(Ti)/n(N(CH₃)₄OH) was selected to be in the range 1-8 and preferably in the range of 2-6. In the present embodiment, tetramethylaminehydroxide pentahydrate (N(CH₃)₄OH.5H₂O) was used giving a molar ratio of n(H₂O)/n(Ti)=150 and a molar ratio of n(Ti)/n(N(CH₃)₄OH)=4. The re-dispersion was selected to be made at 40-100° C. for 0.5-12 hours and preferably at 70-90° C. for 0.5-6 hours under slow stirring. In the present embodiment, the mixture was heat treated at approximately 80° C. for 1 h and then the oil bath heater was turned off. The mixture was heat-treated in a 250 cm³ E-flask capped with a Teflon lined glass stopper in an oil bath and stirred at ca. 100 rpm.

The mixture was transferred to a Teflon cup or similar inert cell and was placed in an autoclave (bomb) so that the liquid occupied 20-70% of the volume and preferably 35-55%. In the particular present embodiment, the mixture occupied 42% of the volume. The mixture was hydrothermally treated at 160-300° C., preferably at 210-270° C., for 1-48 hours, preferably 2-20 hours. In the particular present embodiment, the mixture was hydrothermally treated at 240° C. for 6 h for producing the nano-sized dispersed particles of TiO₂ with the anatase structure and was then cooled to room temperature with the rate of the oven when turned off. The autoclaved mixture was stored for typically 1-200 days, preferably 2-130 days, and in this particular embodiment for 125 days before use.

To increase the dry weight of the stored mixture to achieve ca. 3 weight-% for film preparation, sedimentation is made. The mixture was centrifuged at 3000 rpm for 30 minutes. The amount of sedimented material is relatively low and only a maximum of 5 cm³ of clear upper solution phase could be removed. The mixture was then de-agglomerated by stirring with a Teflon bar. Evaporation of water and organic residues was after an initial pre-heating period made at 450° C. for 30 minutes.

A polyfunctional organic polymer, carbowax or similar, was added to the resulting mixture. The mixture should be added carbowax or similar amounting to about 10-80 weight % of the solid content of TiO₂, preferably 40-60 weight %, in this particular embodiment 50 weight %. The carbowax was allowed to be homogenized within the mixture by 10-40 hours of stirring, preferably 15-30 hours of stirring, and in the particular present embodiment by stirring for 24 h before use.

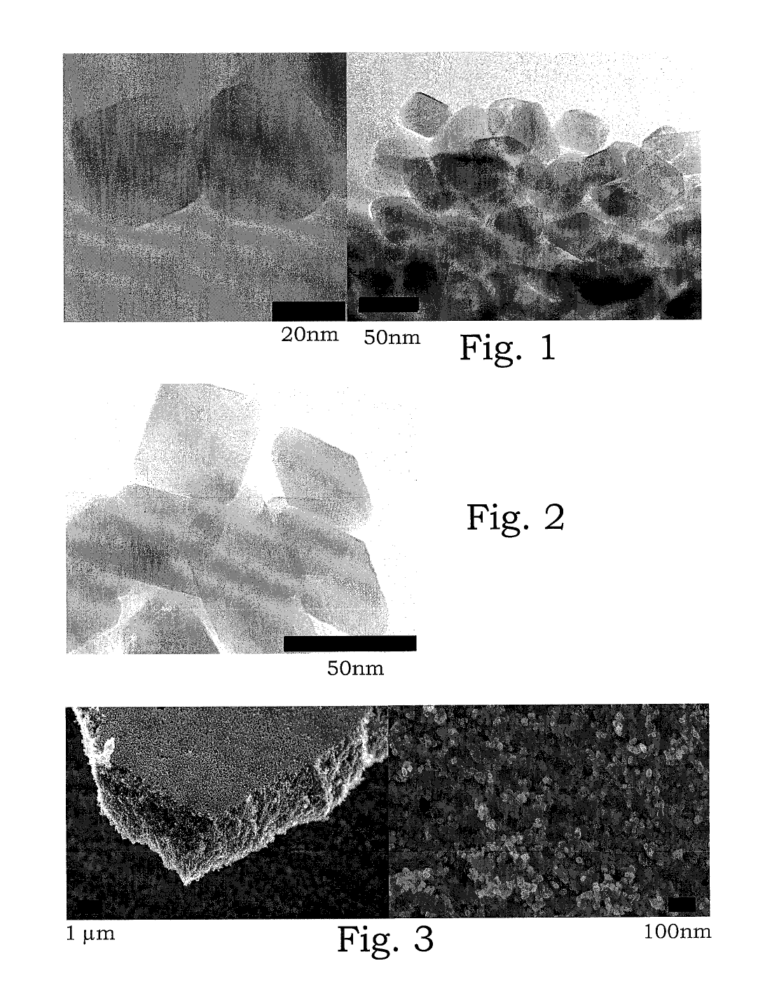

An example of a TEM image of anatase particles prepared according to the method described here above is shown in FIG. 2. Anatase TiO₂ nanocrystals with an average diameter of about 40 nm are inferred to expose {101}, {112}, {100}, {111} and {001} crystal faces (c.f. also FIGS. 8-11).

FIG. 3 depicts a scanning electron microscopy image of a thin film containing 25 nm anatase nanoparticles. Similar films containing 40 nm anatase nanoparticles have also been prepared. Nano-structured films with thicknesses in the range of 0.5-3.0 μm were produced from diluted pastes obtained by the procedures described in Example 1 and Example 2 above according to the following description. Pastes with a dry-weight of 13.5% were diluted to a mixture with a dry-weight of approximately 0.65%. The mixture was typically made from 0.29 g of the paste, 13.5 weight %, diluted with 5.64 cm³ of de-ionized water and was acidified with 0.06 cm³ of concentrated acetic acid, 99.8% AcOH, added drop-wise. The mixture was stirred at 150 rpm for a minimum of 24 h before being used or until no sedimentation could be seen when there was no stirring applied. The substrates were masked with polyimide (PI) tape giving an area for coating of typically 0.5-2.0 cm² in size. The amount of mixture to deposit was estimated from the required thickness and area to be deposited, knowing that the porosity becomes in the range 30-60%, with the applied parameters, and that the density (ρ) of oxide is 3.89 g/cm³ for anatase TiO₂. The mass of solid oxide-material in the film equals the dry-weight of the mixture to be deposited. The mixtures of 0.65 weight % were deposited drop-wise into the masked area and allowed to evaporate the water off in air. When the deposited film had dried, a heat treatment at 450° C. for 30 minutes was made by raising the temperature with 7° C. per minute, starting at 25° C., in a programmable muffle furnace. The heat treatment was conducted in air to remove residual water and organic groups, to obtain the nano-structured oxide film of typically 1.0-2.5 μm thickness.

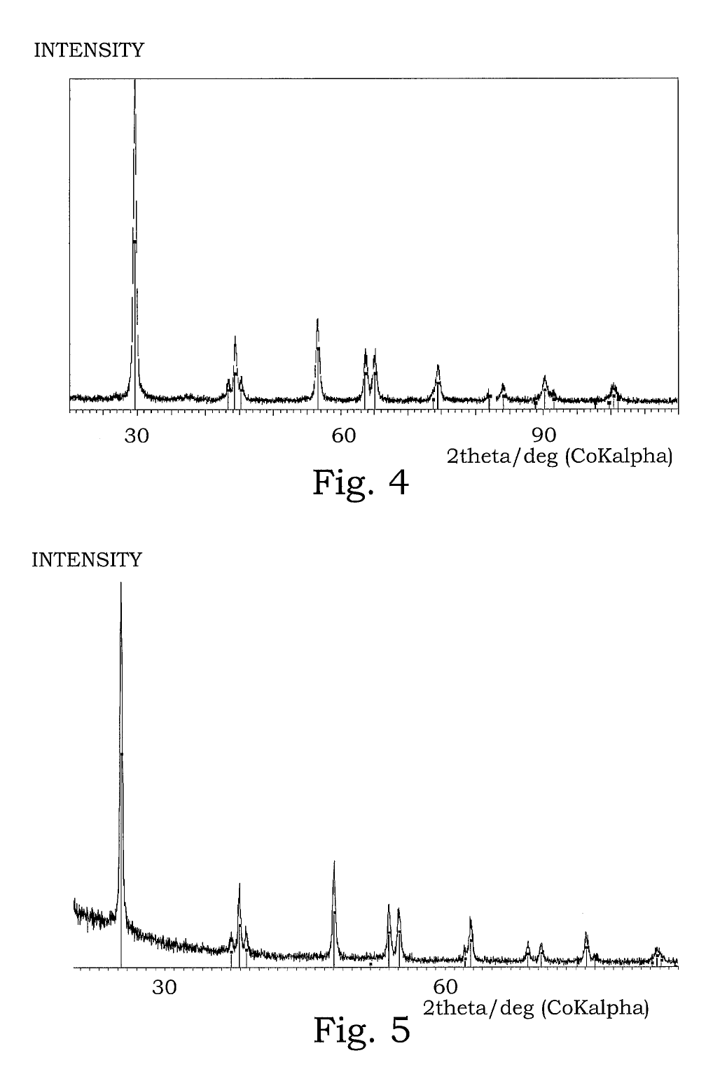

In FIG. 1 and FIG. 2 transmission electron microscopy (TEM) images of anatase TiO₂ nanoparticles with 25 nm and 40 nm mean diameter, respectively, are shown. In FIG. 4 an X-ray diffractogram of the anatase TiO₂ nanoparticles with an average particle size with a diameter of 25 nm is shown. Likewise in FIG. 5, an X-ray diffractogram of the anatase TiO₂ nanoparticles with an average particle size with a diameter of 40 nm is shown. The XRD diffraction lines from the standard JPCD 21-1272 card are included as bars in the figures. The mean size of the particles determined from a Scherrer analysis of the (101) peak in the X-ray diffractograms are 25 nm and 40 nm. Detailed analysis shows that the crystals are of tetragonal anatase structure with unit cell dimensions: a=b=3.776 Å, and c=9.502 Å.

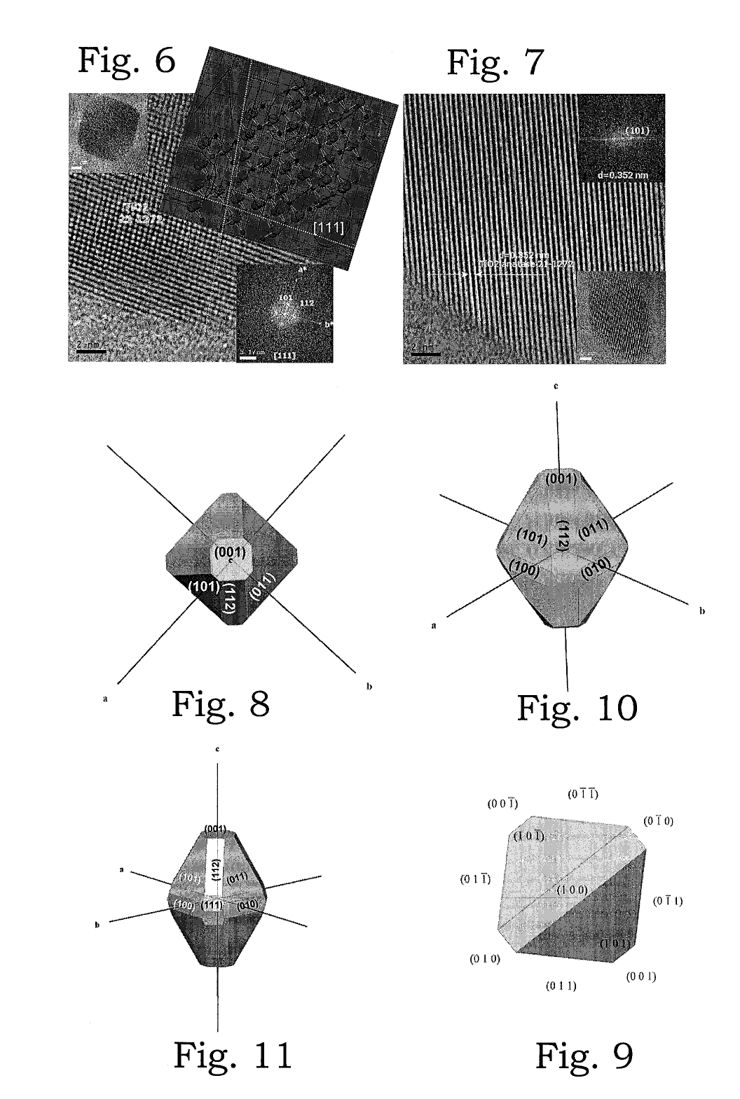

FIGS. 6 and 7 illustrate high resolution TEM micrographs showing the atomically resolved images of 25 nm and 40 nm anatase TiO₂ nanocrystals, respectively, orientated in different directions with respect to the imaging plane. In the insets are shown TEM images of the whole particle and selected area electron diffractograms (SAED) patterns of the nanocrystals. The SAED patterns emanate from narrow regions containing the particle explicitly showing the atomic structure. In left panel an atomic model is overlaid the HRTEM images to explicitly show the atomic arrangement of the crystal using the ATOMS v6.3.1 software.

The three-dimensional particle morphology that simultaneously fits the observed particles with bright-field TEM, SAED and XRD data is depicted in FIGS. 8-11 with associated crystal facets indicated (Win Morph software). It is seen that the particles exposes families of {101}, {111}, {112}, {100} and {001} crystal facets. In the example shown in FIG. 9 the ratio of {101} facets to total particle area of the nanoparticles is 75%, the ratio of {100} facets to total particle area of the nanoparticles is 15%, the ratio of {001} facets to total particle area of the nanoparticles is 10%. The latter morphology is associated preferentially with the 25 nm anatase TiO₂ samples. In the example shown in FIG. 10 the ratio of {101} facets to total particle area of the nanoparticles is 51%, the ratio of {112} facets to total particle area of the nanoparticles is 31%, the ratio of {100} facets to total particle area of the nanoparticles is 12%, and the ratio of {001} facets to total particle area of the nanoparticles is 6%. In the example shown in FIG. 11 the ratio of {101} facets to total particle area of the nanoparticles is 44%, the ratio of {112} facets to total particle area of the nanoparticles is 32%, the ratio of {100} facets to total particle area of the nanoparticles is 9%, the ratio of {001} facets to total particle area of the nanoparticles is 4%, and the ratio of {111} facets to total particle area of the nanoparticles is 11%. The latter two morphologies are associated preferentially with the 40 nm anatase TiO₂ samples.

In Table 1 and 2 are shown the measured photocatalytic degradation rate of formic acid and acetone, respectively, preadsorbed on thin films of anatase TiO₂ nanoparticles with morphology and structure as described in the disclosure.

TABLE 1
Measured rate constant for photocatalytic degradation of
formic acid adsorbed on various samples containing
different types of TiO₂ nanocrystals.

| Sample | Degradation rate (min⁻¹) |
|---|---|
| A40 | 0.09 |
| A25 | 0.06 |
| Rutile 3 × 5 | 0.0015 |
| Rutile 6 × 80 | 0.0011 |
| P25 | 0.006 |

TABLE 2
Measured rate constant for photocatalytic degradation of
acetone adsorbed on various samples containing
different types of TiO₂ nanocrystals.

| Sample | Degradation rate (min−1) |
|---|---|
| A5 | 0.09 |
| A25 | 0.36 |
| A40 | 0.64 |
| rutile | 0.05 |

Sample denoted “A25” and “A40” contain 25 nm and 40 nm diameter anatase nanocrystals, respectively, exposing {112}, {111} and {100} crystal faces in addition to the common {101} and {001} faces as described above. Sample “P25” is the commercially available TiO₂ powder sample provided by Degussa NG which is typically used as a reference photocatalyts. Samples denoted “Rutile 3×5” and “Rutile 6×80” contains rutile TiO₂ nanocrystals, where the latter mainly expose {110} crystal faces. Sample “A5” contains anatase nanocrystals with an average diameter of 5 nm. The experiments were performed with simulated solar light employing AM1.5 filters and water filters resulting in a spectral distribution ranging from 280-800 nm. The calibrated total photon flux power was measured to be 165 mW cm⁻², and 16 mW cm⁻² for λ<390 nm corresponding to the band gap energy of bulk anatase. The data are based on in situ FTIR spectroscopy by monitoring the time evolution of adsorbed formic acid species including dissociation products. The data have been normalized to the initial surface coverage and the reaction rates are thus inter-comparable between the different TiO₂ thin films. The A25 and A40 samples prepared according to the present disclosure have at least an order of magnitude higher photodegradation rate.

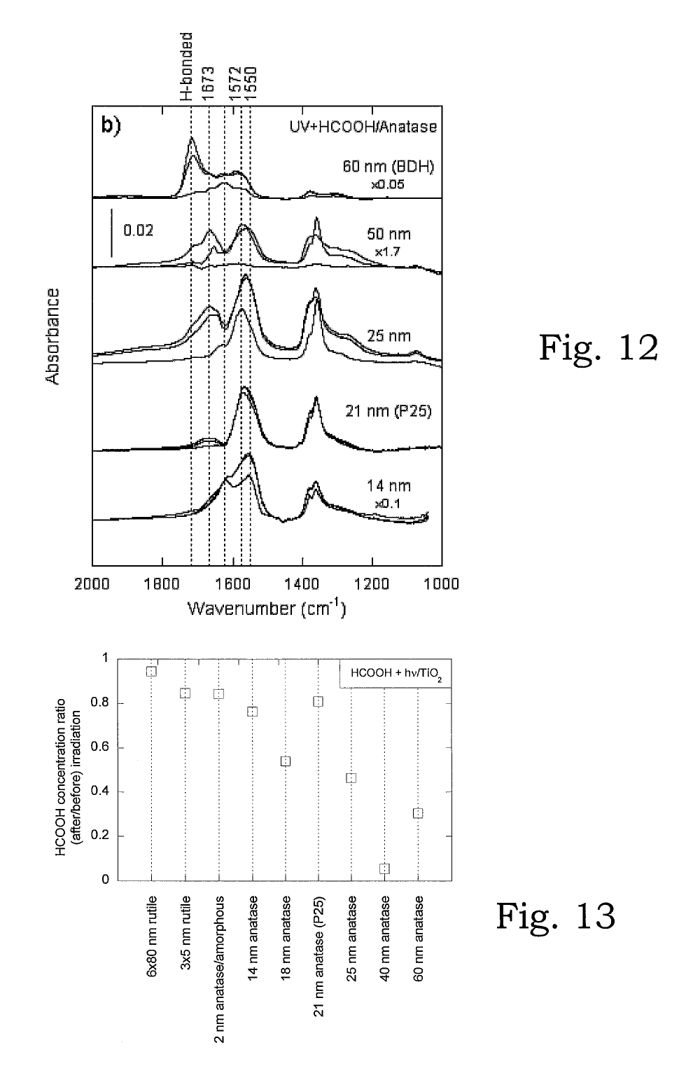

FIG. 12 shows in situ Fourier transform infrared (FTIR) spectra before and after 6 and 48 min of simulated solar illumination of formic acid adsorbed on a wide range of anatase TiO₂ nanoparticle samples. The experiments were performed with simulated solar light employing AM1.5 filters and water filters resulting in a spectral distribution ranging from 280-800 nm. A 200 W Xe lamp was used as light source. The calibrated total photon flux power was measured to be 165 mW cm⁻², and 16 mW cm⁻² for wavelength less than 390 nm corresponding to the band gap energy of bulk anatase. The data are based on in situ FTIR spectroscopy by monitoring the time evolution of adsorbed formic acid species including dissociation products. The data have been normalized to the initial surface coverage and the reaction rates are thus inter-comparable between the different TiO₂ thin films. The spectra for each family of nanocrystals are shifted and have been multiplied by the indicated factor. The FTIR spectra clearly show the photodegradation. The spectra also include measurements on P25 from Degussa AG mentioned above. It is clearly seen that the reactivity is highest on the anatase TiO₂ exposing a large fraction of {112}, {111}{001} and {100} faces, with the 40 nm particles showing the highest reactivity. There is a correlation between the reactivity of the particles and the Ti—O—Ti angles present in the surface planes of bulk terminated structures cleaved along the crystal axis defining the surface planes characterizing the various particles. Based on comparisons with data on anatase particles exposing a high fraction of {101} faces (top spectra) and rutile particles exposing mainly (110) planes [21, 22] as well as samples containing nanoparticles with about equal ratios of (110) and (101) planes [21], we attribute the high photocatalytic reactivity on the 40 nm anatase TiO2 to the high fraction of {112}, {111}, {001} and {100} planes exposed on these particles.

The comparisons are summarized in FIG. 13, where the ratio of the surface concentration of formic acid and intermediate residual products before and after solar light irradiation is shown for a wide range of TiO₂ samples. In both panels the TiO₂ samples denoted “25 nm” and “40 nm” exhibit the beneficial surface atomic arrangement described in the disclosure, with the 40 nm particle being the most reactive sample. The reason is the following: The nearest neighbor Ti—Ti distance is similar on all anatase surfaces on the 40 nm anatase particles and considerably longer than on the rutile (110). This leads to a situation where bidentate coordination of formate, or in general any carboxylate, does not occur. In fact, on the anatase (101) surface formic acid does not dissociate at all [5]. In contrast, on rutile (110) this leads to fast formic acid dissociation and formation of strongly bonded bridge-bonded bidentate coordinated formate species that resist oxidation and therefore inhibit the photocatalytic reaction. It is beneficial for the photocatalysis to maintain moderate bonding of surface intermediates, intermediate between the anatase (101) which is non-reactive, and rutile (110) which is too reactive, i.e. binds formate too strongly. Possible surface coordination of carboxylates to the TiO₂ surface is depicted in FIG. 15. There is shown η¹-coordination monodentate, η²-coordination chelating, μ-coordination bridging bidentate, monoatomic bridging and monoatomic bridging with additional bridging. This is accomplished by suitable combinations of the reactive {112}, {111}, {100} and {001} faces of anatase. Facet communication by means of surface diffusion between the different crystal faces may also contribute to the observed reactivity thus providing an explanation for an optimum particle size which correlates with an effective diffusion length on the nanocrystals. It has previously been shown that the photocatalytic oxidation of monodentate species is faster than bidentate on rutile TiO₂ nanoparticles [21]. Our FTIR spectra show that strong bidentate coordination is suppressed on TiO₂ nanoparticles exhibiting a mixture of {101}, {100}, {111}, {112} and {001} faces, while they are still enough reactive to form monodentate formate species. The importance of the {112}, {111}, {100} and {001} faces is to increase the formic acid dissociation rate and promote bonding of monodentate coordinated species. In contrast on the (101) planes on anatase molecular adsorption of HCOOH occurs forming hydrogen-bonded, liquid-like clusters on the surface as evidenced by FTIR spectra. Oxidation of these clusters is slow due to diffusion of oxidizing agents. Based on the experimental results we thus suggest that the beneficial photocatalytic activity of the particles is due to a balance between moderately strong adsorption on reactive minority faces leading to monodentate carboxylate coordination and facile oxidation of these species by photo-induced radicals. Facile oxygen radical formation on minority faces can contribute to the observed reactivity.

The present invention thus shows ways to modify the coordination of carboxylic groups to TiO₂ surfaces by appropriate selection of TiO₂ nanocrystals with appropriate size that exhibit large fractions of {112}, {111}, {100} and {001} faces. This can as described above facilitate either dissociative adsorption leading to bridging bidentate coordination, monodentate coordination or non-dissociated carboxylic acid adsorption. This opens ways to modify and optimize metal-organic dye attachments to TiO₂ nanoparticles used in e.g. wet solar cells and biomaterials and bio-imaging applications.

In conclusion, the present disclosure describes methods and principles to prepare TiO₂ nanoparticles with appropriate size and surface atomic arrangement that are beneficial for achieving high photocatalytic activity. In particular we describe the photocatalytic oxidation of simple organic molecules on anatase TiO₂ nanoparticles prepared by solution based methods that expose large areas of {112}, {111}, {100} and {001} crystal faces co-existent with {101} crystal faces. The principle mechanisms responsible for their reactivity are outlined and methods to tune the reactivity for desired purposes are described. The invention also embodies methods to coat the photocatalytic materials on various substrates for practical applications. The invention also describes methods to modify the coordination of carboxylic acids to TiO₂ by choosing appropriately faceted crystalline TiO₂ nanoparticles.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

### REFERENCES

1. A. Fujishima, X. Zhang, D. A. Tryk, Surf. Sci, Rep. 63 (2008) 515,
2. M. Lazzeri, A. Vittadini, A. Selloni, Phys. Rev. B 63 (2001) 155409.
3. G. S. Herman, Z. Dohnalek, N. Ruzycki, U. Diebold, J. Phys. Chem. B 107 (2003) 2788.
4. A. Tilocca, A. Selloni, J. Phys. Chem. B 108 (2004) 19314.
5. A. Vittadini, A. Selloni, F. P. Rotzinger, M. Gratzel, J. Phys. Chem. B 104 (2000) 1300.
6. C.-Y. Wang, H. Groenzin, M. J, Shultz, J. Am. Chem. Soc. 126 (2004) 8094.
7. H. G. Yang, C. H. Sun, S. Z. Qiao, J. Zou, G. Liu, S. C. Smith, H. M. Cheng, G. Q. Lu, Nature 453 (2008) 638.
8. D. Byun, Y. Jin, B. Kim, J. K. Lee, D. Park, J. Hazard. Mater. 73 (2000) 199.
9. B. Kim, D. Byun, J. K, Lee, D. Park, Jpn, J. Appl. Phys. 41 (2002) 222.
10. J. Jhin, J, Choi, J. H. Baek, D. Byun, (Eds.), Diffusion and Defect Data—Solid State Data B: Solid State Phenomena, Vol, 2, 2007, pp. 1509.
11. S. Tokita, N. Tanaka, S. Ohshio, H. Saitoh, J. Ceram. Soc. Jpn. 111 (2003) 433.
12. T. Ohno, K. Sarukawa, M. Matsumura, New J. Chem, 26 (2002) 1167.
13. T. Taguchi, Y. Saito, K. Sarukawa, T. Ohno, M. Matsumura, New J, Chem. 27 (2003) 1304.
14. X.-Q. Gong, A. Selloni, J. Phys. Chem. B 109 (2005) 19560.
15. W. K. Li, X. Q. Gong, G. Lu, A. Selloni, J. Phys. Chem. C 112 (2008) 6594.
16. C. J. Bathe, F. Arendse, P. Comte, M. Jirousek, F. Lenzmann, V. Shklover, M. Gratzel, J. Am. Ceram. Soc. 80 (1997) 3157.
17, Y. Gao, S. A. Elder, Materials Letters 44 (2000) 228.
18. J. Yang, S. Mei, J. M. F. Ferreira, J of Colloid and Interface Science 260 (2003) 82.
19, J. Yang, S. Mei, J. M. F. Ferreira, Materials Science and Engineering C 15 (2001) 183.
20. S. Hore, E. Palomares, H. Smit, N. J. Bakker, P. Comte, P. Liska, K. R. Thampi, J. M. Kroon, A. Hinschae, J. R. Durrant, J. Mater. Chem. 15 (2005) 412.
21. M. Andersson, A. Kiselev, L. Österlund, A. E. C. Palmqvist, J. Phys. Chem. C 111 (2007) 6789.
22. L. Österlund, A. Mattsson, (Eds.), A. Surface characteristics and electronic structure of photocatalytic reactions on TiO₂ and doped TiO₂ nanoparticles. In Solar Hydrogen and Nanotechnology, Vol. 6340, SPIE, 2006, pp. 5.
23. A. Mattsson, M. Leideborg, K. Larsson, G. Westin, L. Österlund, J. Phys. Chem. B 2006 110, pp. 1210-1220.
24. J. H. Kim, W. Y, Jung, S. H. Baek, K.-T. Lim, G.-D. Lee, S. S. Park, S.-S. Hong, Chem. Eng. Sci. 62 (2007), pp. 5154-5159.

1. Photocatalytic material, comprising:
anatase TiO₂ nanoparticles;
said anatase TiO₂ nanoparticles having a mean diameter of less than 100 nm and at least one of a {111}, a {112}, and a {100} crystal face.

2. Photocatalytic material according to claim 1, wherein said anatase TiO₂ nanoparticles crystals have {112} crystal faces.

3. Photocatalytic material according to claim 2, wherein said anatase TiO₂ nanoparticles have a fraction of {112} crystal faces to total surface area of less than 50%, preferably between 20-40%.

4. Photocatalytic material according to claim 1, wherein said anatase TiO₂ nanoparticles have {111} crystal faces.

5. Photocatalytic material according to claim 4, wherein said anatase TiO₂ nanoparticles have a fraction of {111} crystal faces to total surface area of less than 20%, preferably between 5-15%.

6. Photocatalytic material according to claim 1, wherein said anatase TiO₂ nanoparticles have {100} crystal faces.

7. Photocatalytic material according to claim 6, wherein said anatase TiO₂ nanoparticles have a fraction of {100} crystal faces to total surface area of between 5-30%, preferably between 5-20%.

8. Photocatalytic material according to claim 1, wherein said anatase TiO₂ nanoparticles have a mean diameter in the range of 20-80 nm, and preferably in the range of 30-60 nm.

9. Photocatalytic material according to claim 1, wherein said anatase TiO₂ nanoparticles are provided in a thin film.

10. Photocatalytic material according to claim 1, wherein said anatase TiO₂ nanoparticles are selectively carboxyl terminated at said at least one of a {111}, a {112}, and a {100} crystal face.

11. Method for manufacturing of anatase TiO₂ nanoparticles according to claim 1, said method comprising the steps of:
mixing (210) Ti-containing alkoxide precursors with a solvent into a precursor solution;
hydrolyzing (212) said precursor solution to yield a mixture of a fine titanium containing precipitate and said solvent;
providing a mixture of a basic medium and said precipitate of said hydrolyzed precursor solution after said step of hydrolyzing (212); said basic medium comprising basic amines diluted with de-ionized water;
heating said mixture to a temperature of 40 to 90° C.; and
hydrothermally treating (214) said mixture at an elevated temperature for 1-48 hours.

12. Method according to claim 11, wherein said Ti-containing alkoxide precursors comprise a titanium (IV) alkoxide including ligands selected from the group of methoxo, ethoxo, propoxo, butoxo, pentoxo and hexoxo ligands, and preferably titanium tetrabutoxide Ti(OBuⁿ)₄.

13. Method according to claim 11, wherein said solvent comprises isopropanol, and preferably comprising also at least one of hexane, pentane, heptane, tetrahydrofuran (THF), benzene, toluene and xylene.

14. Method according to claim 11, wherein said precursor solution is rapidly and drop-wise added to de-ionized water in a stream of an inert gas flow under vigorous stirring of the de-ionized water.

15. Method according to claim 11, wherein said step of hydrothermally treating (214) is performed in an autoclave so that the liquid takes up 20-80% of the volume and using a temperature of 160 to 300° C., preferably 180 to 270° C., most preferably around 200 to 240° C.

16. Method according to claim 11, wherein said step of hydrothermally treating (214) is performed for 2 to 20 hours.

17. Method according to claim 12, wherein said solvent comprises isopropanol, and preferably comprising also at least one of hexane, pentane, heptane, tetrahydrofuran (THF), benzene, toluene and xylene.

18. Method according to claim 12, wherein said precursor solution is rapidly and drop-wise added to de-ionized water in a stream of an inert gas flow under vigorous stifling of the de-ionized water.

19. Method according to claim 13, wherein said precursor solution is rapidly and drop-wise added to de-ionized water in a stream of an inert gas flow under vigorous stifling of the de-ionized water.

20. Method according to claim 17, wherein said precursor solution is rapidly and drop-wise added to de-ionized water in a stream of an inert gas flow under vigorous stifling of the de-ionized water.
